(19) United States
(12) Patent Application Publication
(10) Pub. No.: US 2007/0162616 A1
(43) Pub. Date: Jul. 12, 2007

(54) METHOD AND SYSTEM FOR IMPLEMENTING AUTOMATED SERVICE PROVISIONING ON A PPP ACCESS TERMINAL

(75) Inventor: Hongguang Li, Shenzhen (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Huawei Technologies Co., Ltd., Shenzhen (CN)

(21) Appl. No.: 11/608,173

(22) Filed: Dec. 7, 2006

Related U.S. Application Data
(63) Continuation of application No. PCT/CN06/02294, filed on Sep. 6, 2006.

(30) Foreign Application Priority Data
Sep. 9, 2005 (CN) 200510099307.2

(51) Int. Cl. G06F 15/16

(52) U.S. Cl. 709/245; 709/220

(57) ABSTRACT

This invention relates to a method and system for implementing Automated Service Provisioning on a PPP Access Terminal. This invention mainly includes: a PPP (Point-to-Point Protocol) Access Terminal first decides the address information of the Network Management/Auto-Configuration Server; the PPP Access Terminal automatically obtains address information required for launching services from the aforementioned Network Management/Auto-Configuration Server, and then launches services by using the aforementioned configuration information, which realizes the corresponding Automated Service Provisioning process. This invention implements an Automated Service Provisioning process under PPP networking conditions to eliminate depending on a DHCP server and avoiding major network rebuilding to protect the investment of the telecommunication operators.

### CROSS-REFERENCES TO RELATED APPLICATIONS

The present application is a continuation of PCT Application No. PCT/CN2006/002294, filed Sep. 6, 2006, which claims priority to Chinese Patent Application No. 200510099307.2, filed Sep. 9, 2005. All of these applications are commonly assigned and incorporated by reference herein for all purposes.

### BACKGROUND OF THE INVENTION

This invention relates to the network communication technology field, in particular, it relates to a method and system for implementing Automated Service Provisioning on a PPP (Point-to-Point Protocol) Access Terminal.

With the development of broadband IP networking, we have seen the emergence of more and more value-added services, as well as a greater variety of CPE (Customer Premise Equipment) terminals which serve as specific service carriers. These aforementioned terminals which serve as premise equipment located on the customer's side can be viewed as an extension of the telecommunication access network. Therefore, it is very important for telecommunication operators to effectively manage these terminals in order to achieve their value-added and operational goals.

The terminal is characterized by their large numbers, vast distribution area, and multiple uplink interfaces, and other features. During the overall operation and maintenance process performed by the operators, door-to-door service for the installation of the terminal occupies a relatively large percentage of the production costs. Therefore, achieving the automatic deployment of services targeted at access terminals has become an area of major concern to operators.

For this reason, a DHCP (Dynamic Host Configuration Protocol)-based automated provisioning process is currently provided to obtain Network Management/Auto-Configuration Server addresses. After obtaining Network Management/Auto-Configuration Server addresses, the terminal can then obtain terminal software and terminal configuration files and other information from the Network Management/Auto-Configuration Server based on the aforementioned addresses, which is required for the terminal to launch a service.

The corresponding automated provisioning process flow is shown in FIG. 1 below, including:

Step 11 to Step 13: A user purchases terminal equipment and applies for services at a Service Registration Office, where they need to provide a terminal identifier, user information, and service application information. The Service Registration Office completes user registration according to the information provided by the user;

Step 14 to Step 16: After completing the registration, the Service Registration Office dispatches the terminal information, user information, and user service application information to the DHCP Server, the network management system, and the service system;

Step 17: The user powers on the terminal equipment;

Step 18: The terminal equipment carrying the terminal identification information requests an IP address from the DHCP Server;

Step 19: The DHCP Server sends network configuration information, terminal network management address, and terminal service address to the terminal equipment;

Step 110 and 111: The DHCP Server sends the terminal IP address and terminal identification mapping association to the network management system and service system, respectively.

Step 112: The terminal equipment requests terminal software and terminal configuration files from Network Management Server based on the acquired network address;

Step 113: The Network Management Server distributes the corresponding terminal software and terminal configuration files to the terminal equipment;

Step 114: The terminal requests services from the Service Server of the service system;

Step 115: The Service Server responds to the terminal's service request. Thus, the terminal is capable of communicating with the Service Server and launching the corresponding services.

In FIG. 1, the core is the terminal acquiring key parameters of the Network Management/Auto-Configuration Server URL (designated information location) through the DHCP Server. Then, the terminal can automatically exchange with the Network Management/Auto-Configuration Server to obtain all the parameters necessary to launch services. The aforementioned parameters include terminal software and terminal configuration files.

In the process shown in FIG. 1, it requires the use of a DHCP Server to distribute IP addresses to the terminal. Therefore, it requires the DHCP Server to verify the validity of the terminal.

Moreover, the current common broadband configuration is shown in FIG. 2, including the managed CPE (acting as a CPE of the B-NT (Broadband Network Terminal) and a CPE of the LAN (Local Area Network, respectively)), and network devices such as a DSLAM (a Broadband Access Multiplexer), BRAS (Broadband Remote Access Server), and RADIUS (Authentication) Server. It is clear that operators often do not deploy a dedicated DHCP Server to distribute IP addresses to the terminals. This leads to the PPP Access Terminal's inability to access the Network Management/Auto-Configuration Server through the DHCP Server. It also is not capable of implementing Automated Service Provisioning process in the network.

Therefore, at present, there is no DHCP Server that distributes IP addresses deployed in the network, or the deployed DHCP Server does not have a terminal validity authentication function, which is unable to implement Automated Service Provisioning process in the network.

### BRIEF SUMMARY OF THE INVENTION

The embodiment of the present invention provides a method and system for implementing Automated Service Provisioning on a PPP Access Terminal. The use of a PPP Access Terminal can automatically achieve service provisioning without relying on a DHCP Server. It thereby effectively avoids the possibility of the telecommunication operator making major modifications to the network.

The embodiment of the present invention provides a method for implementing Automated Service Provisioning on a PPP Access Terminal, including:

The PPP Access Terminal determines the address information of the Network Management/Auto-Configuration Server;

The PPP Access Terminal automatically obtains configuration information needed for launching services from the Network Management/Auto-Configuration Server based on the aforementioned address information;

The PPP Access Terminal uses the aforementioned configuration information to launch services.

The process of the aforementioned PPP Access Terminal determines the Network Management/Auto-Configuration Server address information, which includes:

After the PPP Access Terminal connects to the network, the PPP server sends the Network Management/Auto-Configuration Server address information with the network layer parameters to the PPP Access Terminal;

Alternatively,

the Network Management/Auto-Configuration Server address information is manually sent to the PPP Access Terminal;

The detailed process of the aforementioned PPP server, which sends the Network Management/Auto-Configuration Server address information with the network layer parameters includes:

After the PPP Access Terminal is turned on, a PPP access request will be generated.

The PPP Access Terminal and the PPP server network layer parameters negotiate and establish a communication link.

The PPP Access Terminal and the PPP server network layer parameters negotiate and obtain an IP address and the Network Management/Auto-Configuration Server address information.

The process of obtaining the aforementioned IP address and Network Management/Auto-Configuration Server address information includes:

The PPP server sends the Network Management/Auto-Configuration Server address information carried by the IP Control Protocol-based IPCP message to the PPP Access Terminal.

In the invention, the process of the said PPP Access Terminal requesting PPP access after it is powered on also includes:

The PPP server determines the Network Management/Auto-Configuration Server address based on local configuration information.

Or,

the PPP Server obtains the aforementioned Network Management/Auto-Configuration Server address from the Network Management/Auto-Configuration Server address information entity.

The aforementioned PPP server includes:

Broadband Access Server (BRAS) or Edge Router (ER).

The aforementioned configuration information required for launching services include:

The PPP Access Terminal requests for terminal software and terminal configuration files in accordance with the address information of the verified Network Management/Auto-Configuration Server.

The PPP Access Terminal obtains and runs the corresponding terminal software and terminal configuration files.

The process of the aforementioned PPP Access Terminal using the above aforementioned configuration information to launch services includes:

The PPP Access Terminal carrying the corresponding terminal software and configuration files requests services from the service system, and the aforementioned service system responds to the service request of the PPP Access Terminal.

The embodiment of the present invention also provides a system for PPP Access Terminal automated provisioning, including a PPP Access Terminal, a PPP Server and a Network Management/Auto-Configuration Server. It also includes: an Address Information Distribution Unit, an Address Information Receiving Unit, or Address Information Configuration Unit. It also includes a Configuration Information Acquisition Unit and a Service Processing Unit, of which:

the Address Information Distribution Unit, installed at the PPP server, sends the Network Management/Auto-Configuration Server address information with the network layer parameters to the PPP Access Terminal, after the PPP Access Terminal network accesses the network;

the Address Information Receiving Unit receives network layer parameters issued by Address Information Distribution Unit through the PPP server. The aforementioned network layer parameters include the address information of the Network Management/Auto-Configuration Server;

the Address Information Configuration Unit, installed at PPP Access Terminal, is used to obtain the configured and imported address information of the Network Management/Auto-Configuration Server;

the Configuration Information Acquisition Unit, installed at PPP Access Terminal, is used to receive the configuration information needed for Automated Service Provisioning from the Network Management/Auto-Configuration Server based on the address information obtained from the Address Information Receiving Unit and the Address Information Configuration Unit;

the Service Processing Unit, located at PPP Access Terminal, is used to launch services using the aforementioned configuration information.

The aforementioned Address Information Distribution Unit is triggered by a PPP access request initiated by the PPP Access Terminal.

The aforementioned Address Information Distribution Unit sends the Network Management/Auto-Configuration Server address information carried by the IPCP-based information to the PPP Access Terminal.

The aforementioned PPP server also includes:

the Address Information Management Unit, which is used for managing the address information of the local PPP Network Management/Auto-Configuration Server.

Or,

the Address Information Acquisition Unit, which is used to obtain the aforementioned address of the Network Management/Auto-Configuration Server from the entity allocated with the Network Management/Auto-Configuration Server address information.

The aforementioned PPP server includes: a Broadband Access Server (BRAS) or an Edge Router (ER).

The embodiment of the present invention also provides a PPP Access Terminal, including:

an Address Information Configuration Unit, which is used to obtain the allocated and imported address information of the Network Management/Auto-Configuration Server;

an Configuration Information Acquisition unit, which is used to automatically obtain the allocated information from the Network Management/Auto-Configuration Server needed for launching services in accordance with the address information of the Address Information Receiving Unit;

Service Processing Unit, which is used to launch services based on the aforementioned configuration information.

The embodiment of the present invention also provides a PPP Access Terminal, including:

an Address Information Receiving Unit is used to receive network layer parameters, which includes address information of the Network Management/Auto-Configuration Server;

an Configuration Information Acquisition unit is used to automatically obtain the configuration information from the Network Management/Auto-Configuration Server needed for launching services in accordance with the address information of the Address Information Receiving Unit;

a Service Processing Unit is used to launch services processing based on the aforementioned configuration information.

The above technical proposal of the invention shows that the PPP Access Terminal can automatically obtain the address information of the automatic configuration server through the PPP Server in order to acquire configuration information needed for launching services. In addition, it can also obtain the aforementioned configuration information through an Auto-Configuration Server in PPP Access Terminal. Therefore, this invention adopts the utilization of a PPP network to achieve Automated Service Provisioning without relying on a DHCP server, thereby avoiding major modification by the network operators and protecting their investment.

### BRIEF DESCRIPTION OF THE DRAWINGS

FIG. 1 is a diagrammatic sketch showing the existing technology for achieving Automated Service Provisioning.

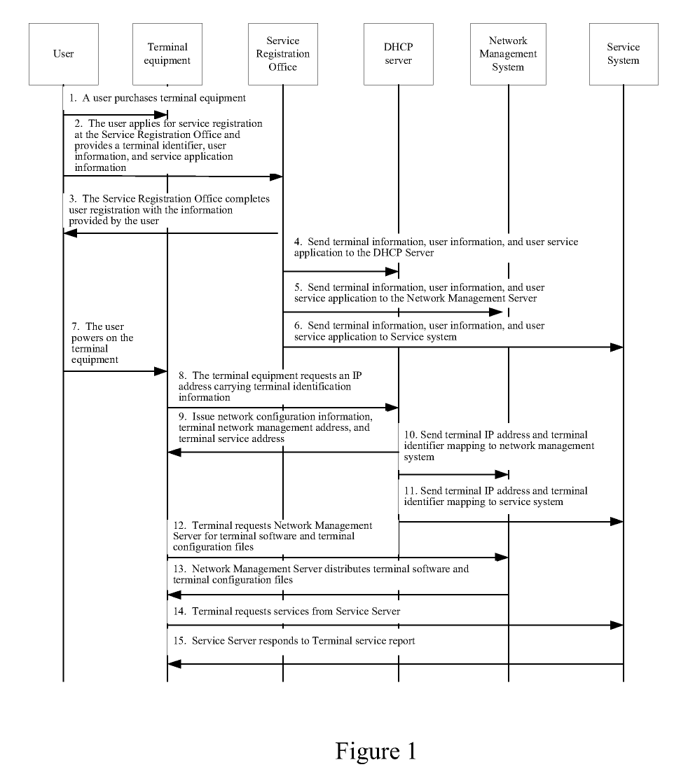

FIG. 2 is a diagrammatic sketch showing the existing broadband network deployment.

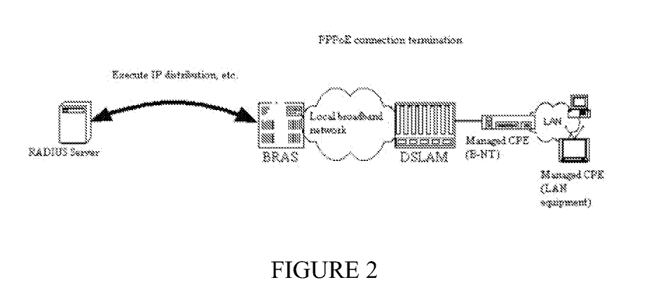

FIG. 3 is a diagrammatic sketch showing the detailed processing procedure for implementing automatic acquisition of the address information from the Network Management/Auto-Configuration Server in this invention.

FIG. 4 shows the detailed processing procedure for implementing Automated Service Provisioning provided by this invention in diagrammatic sketch 1.

FIG. 5 shows the detailed processing procedure for implementing Automated Service Provisioning provided by this invention in diagrammatic sketch 2.

FIG. 6 is a diagrammatic sketch showing the structure of the concrete implementation of the system described in this invention.

### DETAILED DESCRIPTION OF THE INVENTION

The core of the embodiment of the present invention is to resolve dynamic and static Network Management/Auto-Configuration Server address acquisition by terminals under the PPP Access Terminal mode, and automatically acquire terminal software and terminal configuration files based on the aforementioned Network Management/Auto-Configuration Server in order to achieve automated service provisioning.

In a PPP Access method, there are two stages, including LCP (Link Control Protocol) and NCP (Network Control Protocol), of which:

(1) In the LCP stage, CPE and Server negotiate link layer parameters to establish communication links.

(2) In NCP stage, CPE and Server negotiate network layer parameters. For IP-based applications, the IPCP (IP Control Protocol) for the NCP can be used to configure IP associated parameters for the terminal equipment, therefore, through the expansion of IPCP Protocol, the ACS (Access Control Server) address, such as Network Management/Auto-Configuration Server address, can be transmitted ().

In the present invention, the detailed expansion content is to add IPCP configuration options based on the IPCP protocol. Through the expansion, the added parameters include: the Network Management/Auto-Configuration Server URL (Uniform Resource Locator Address), that is, the Network Management/Auto-Configuration Server address.

In the present invention, after user authentication is passed using the standard PPP IPCP process, the RADIUS Authentication Server (remote authentication dial-in user service) responsible for handling PPP server authentication returns the server IP address, DNS (domain name system) address, and Network Management/Auto-Configuration Server URL to the terminal.

The URL address of the Network Management/Auto-Configuration Server can be deployed in the PPP server, such as BRAS and ER (Edge Router), or can be deployed in other servers, that the PPP server may acquire through certain protocols.

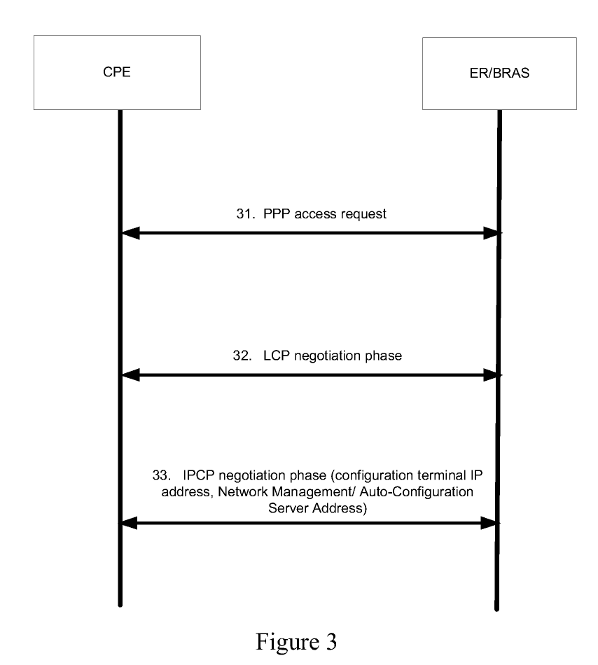

In the embodiment of the present invention, the operation flow automatically acquires the address of the Network Management/Auto-Configuration Server from the PPP Server as shown in FIG. 3. Specific steps include:

Step 31: Power on the terminal, initiate PPP access request, and establish PPP connection.

Step 32: User terminal and PPP Server (ER/BRAS) negotiate link layer parameters through LCP protocol, and establish communication links.

Step 33: User terminal and PPP Server (ER/BRAS) negotiate IP layer parameters, including IP address and Network Management/Auto-Configuration Server address through IPCP protocol.

To facilitate the understanding of the embodiment of the present invention, the embodiment of this invention will be described with reference to the diagrams.

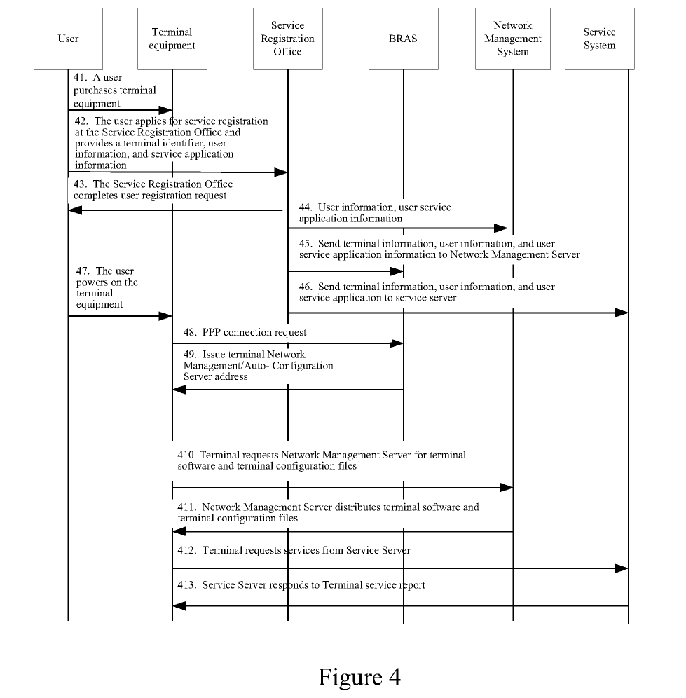

The implementation procedure in the application example 1 of the Automated Service Provisioning flow based on the PPP Uplink mode for acquiring the Network Management/ Auto-configuration Server address is shown in FIG. 4. The detailed steps may include the following:

Step 41 to 43: A user purchases terminal equipment and registers for services at Service Registration Office. At the same time it is needed to provide a terminal identifier, user information, and user service application information. The Service Registration Office processes user registration based on the information provided by the user.

Step 44 to Step 46: After completing the user registration, the Service Registration Office sends user information and user service application information to the BRAS (Broadband Remote Access Server), and sends user terminal information, user information, and user service application information to the network management system and service system.

Step 47: Power on the user terminal equipment.

Step 48: After the terminal equipment is powered on, it launches a PPP connection request to the BRAS, requesting establishing a PPP connection with the BRAS.

Step 49: BRAS issues the address of the Network Management/Auto-Configuration Server to the terminal equipment.

Step 410: The terminal equipment requests terminal software and terminal configuration files, according to the obtained address of the network management, from the network management server of network management system.

Step 411: Network Management Server distributes the corresponding terminal software and terminal configuration files to the terminal equipment.

Step 412: The terminal equipment requests the Service Server of the service system for services.

Step 413: The Service Server responds to the request of the terminal equipment. Thus, the terminal is able to communicate with the service system and perform related services.

The technical solution provided by the embodiment of the present invention shown in FIG. 4 is a fully automated process. Taking into consideration the realities of the network environment, this solution can come up with a compromise, that is, a manual configuration of the Network Management/Auto-Configuration Server address is implemented on the terminal equipment, and then implementing the Automated Service Provisioning process based on the configured Network Management/Auto-Configuration Server address.

In this solution, for terminal equipment with display interface or terminal equipment installed with PC equipment etc, a manually deployed Network Management/Auto-Configuration Server address can be provided through the end-user interface provided by the terminal equipment or by connecting the terminal equipment to the PC equipment. It only needs the configuration of the Network Management/Auto-Configuration Server address and network access authentication parameters, such as PPPoE (based on point-to-point Ethernet-based protocol)user name and password, and thus Automated Service Provisioning can be achieved.

This implementation solution does not need expansion of the PPP protocol. In the meantime, there is also no change to the BRAS equipment in the existing network.

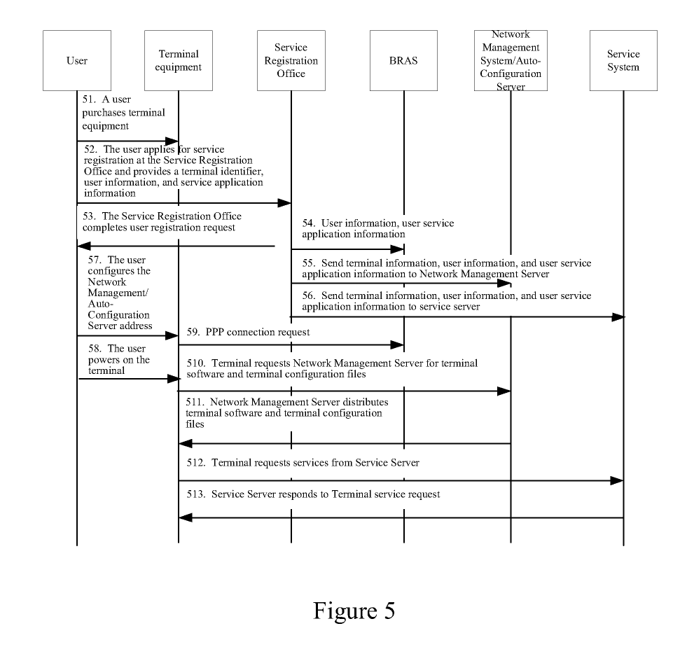

This concrete application example provides a complete Automated Service Provisioning processing flow as shown in FIG. 5.

The detailed steps include the following:

Step 51 to 53: A user purchases terminal equipment and applies for service registration at the Service Registration Office. In the meantime, it is needed to provide the Service Registration Office with the terminal identifier, user information, and user service application information. The Service Registration Office processes the registration according to the information provided by the user.

Step 54 to Step 56: After the Service Registration Office completes service registration, it distributes the user information and user service application information to the BRAS (Broadband Remote Access Server), and distributes the terminal information, user information, and user service application information to the network management system/auto-configuration server and the service system.

Step 57: The user manually configures the Network Management/Auto-Configuration Server address information.

Step 58: Power on the terminal equipment.

Step 59: After the terminal equipment is powered on, it launches the PPP connection request to the BRAS to facilitate implementation of subsequent processing based on this PPP connection.

Step 510: After establishment of the PPP connection, the terminal equipment requests terminal software and terminal configuration files, according to the obtained address of the network management, from the Network Management Server of the network system.

Step 511: Network Management Server distributes corresponding terminal software and terminal configuration files to the terminal equipment.

Step 512: The terminal equipment requests service from the Service Server of the service system.

Step 513: Service Server responds to the terminal service request. Thus, the terminal equipment is able to communicate with the service system, and launch the associated services.

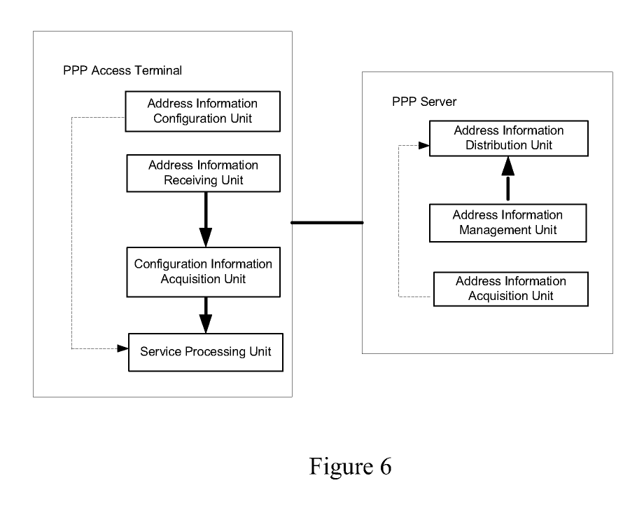

The embodiment of the present invention also provides a system for PPP Access Terminal to realize an Automated Service Provisioning, which includes the PPP Access Terminal, the PPP Server, and the Network Management/Auto-Configuration Server (not shown in the drawing). The detailed realization structure is shown in FIG. 6, which includes the following two implementation solutions

Implementation Solution I:

As shown in FIG. 6, the described system includes an Address Information Distribution Unit, an Address Information Receiving Unit, a Configuration Information Acquisition Unit, and a Service Processing Unit, of which:

(1) The Address Information Distribution Unit, installed at the PPP server, which is used for sending the Network Management/Auto-Configuration Server address information with the network layer parameters to the PPP Access Terminal, after the PPP Access Terminal accesses the network. Specifically, in the LCP stage, the CPE and Server negotiate link layer parameters to establish communication links. In the following NCP stage, the CPE and Server negotiate network layer parameters. During the negotiation of network layer parameters, the PPP Server distributes the aforementioned address information of the Network Management/Auto-Configuration Server to the PPP Access Terminal.

The aforementioned Address Information Distribution Unit is activated by a PPP access request sent by a PPP Access Terminal. In other words, the PPP Server receives the PPP Access Terminal request, triggers the aforementioned Address Information Distribution Unit and sends the address information of the Network Management/Auto-Configuration Server to the PPP Access Terminal.

The aforementioned Address Information Distribution Unit sends the address information of the Network Management/Auto-Configuration Server carried by the IPCP-based message to the PPP Access Terminal.

(2) The Address Information Receiving Unit, installed at PPP Access Terminal, is used to receive network layer parameters issued by the Address Information Distribution Unit through the PPP server. The aforementioned network layer parameters include the address information of the Network Management/Auto-Configuration Server so that the PPP Access Terminal will successfully obtain the address information of the corresponding Network Management/Auto-Configuration Server.

(3) The Configuration Information Acquisition Unit

The Configuration Information Acquisition Unit, installed at PPP Access Terminal, is used to automatically obtain the configuration information needed to launch services from Network Management/Auto-Configuration Server in accordance with the address information of the Address Information Receiving Unit, that is, when the PPP Access Terminal obtains Network Management/Auto-Configuration Server address information, it automatically launches a process to the Network Management/Auto-Configuration Server for obtaining configuration information, so that the PPP Access Terminal successfully acquire the configuration information needed for launching services.

(4) The Service Processing Unit, installed in the PPP Access Terminal, is used to launch services based on the aforementioned configuration information.

During the implementation of Solution I, the PPP Server needs to send the address information of the aforementioned Network Management/Auto-Configuration Server to the PPP Access Terminal. Therefore, the PPP Access Terminal first needs to have the corresponding address information of Network Management/Auto-Configuration Server. The aforementioned PPP Server also includes:

The Address Information Management Unit, which is used for managing, locally at the PPP server, the address information of the Network Management/Auto-Configuration Server. For example, the address information of the corresponding Network Management/Auto-Configuration Server is configured and stored directly in the PPP Server and managed by the Address Information Management Unit.

Or,

The Address Information Acquisition Unit, which is used to obtain the aforementioned address information of the Network Management/Auto-Configuration Server from the deployed entity configured with address information of the Network Management/Auto-Configuration Server. The details are specified as follows: it performs a process for obtaining the address information when it is needed to send to the PPP Access Terminal aforementioned address information of the Network Management/Auto-Configuration Server. Or it can obtain the address information of the Network Management/Auto-Configuration Server during the other processing periods.

Based on the above Solution I, the corresponding PPP Access Terminal implementation structure may include:

An Address Information Receiving Unit, being used to receive network layer parameters issued by the PPP server. The aforementioned network layer parameters include the address information of the Network Management/Auto-Configuration Server.

A Configuration Information Acquisition Unit, being used to automatically receive the configuration information needed to launch services from the Network Management/Auto-Configuration Server according to the address information obtained from the Address Information Receiving Unit.

A Service Processing Unit, being used to launch services by using the aforementioned configuration information.

Implementation Solution II

As shown in FIG. 6, the described system includes an Address Configuration Unit, a Configuration Information Acquisition Unit, and a Service Processing Unit.

The Address Information Configuration Unit, installed at the PPP Access Terminal, is used to obtain the configured input address information of the Network Management/Auto-Configuration Server. For example, it is possible to manually input the configuration information through the configuration interface provided.

The Configuration Information Acquisition Unit, installed at PPP Access Terminal, is used to automatically obtain configuration information needed for launching services from Network Management/Auto-Configuration Server in accordance with the address information configured by the Address Information Configuration Unit; that is, if the PPP Access Terminal learns the address information of the Network Management/Auto-Configuration Server, it may automatically initiate a process procedure for obtaining said configuration information to the Network Management/Auto-Configuration Server, so that the PPP Access Terminal successfully acquires the configuration information needed for launching services.

The Service Processing Unit, installed at the PPP Access Terminal, is used to launch services based on the aforementioned configuration information.

The aforementioned PPP Server in the embodiment of the present invention may be: BRAS or ER.

Based on the above Solution II, the corresponding structure of PPP Access Terminal in detailed implementation includes:

An Address Information Configuration Unit, being used to obtain the configured input address information of the Network Management/Auto-Configuration Server.

A Configuration Information Acquisition unit, being used to automatically obtain the configuration information needed to launch services from the Network Management/Auto-Configuration Server, in accordance with the address information of the Address Information Configuration Unit.

A Service Processing Unit, being used to launch services based on the aforementioned configuration information.

In summary, the embodiment of the present invention implements an Automated Service Provisioning process under PPP networking conditions to eliminate relying on the DHCP server and avoiding major network rebuilding to protect the investment of the telecommunication operators.

As stated above, this invention may be embodied in other specific forms without departing from the spirit or essential characteristics of said invention. The embodiments disclosed in this application are to be considered in all respects as illustrative and not restrictive, the scope of the invention being indicated by the appended claims rather than by the foregoing description. Therefore, all changes that come within the meaning and range of equivalency of the claims are intended to be embraced therein.

1. A method for implementing automated service provisioning on a PPP access terminal, wherein comprising:
a point-to-point protocol (PPP) access terminal determining address information of a network management/auto-configuration server;
the PPP access terminal automatically acquiring configuration information needed for launching a service, from the network management/auto-configuration server based on the address information;
the PPP access terminal launching the service using the configuration information.

2. The method for implementing automated service provisioning on the PPP access terminal according to claim 1, wherein the process of said PPP access terminal determining the address information of the network management/auto-configuration server comprises:
after the PPP access terminal accessing a network, a PPP server sending the address information of the network management/auto-configuration server, along with network layer parameters, to the PPP access terminal;
or,
manually configuring the address information of the network management/auto-configuration server in the PPP access terminal.

3. The method for implementing automated service provisioning on the PPP access terminal according to claim 2, wherein the detailed process of said PPP server sending the address information of the network management/auto-configuration server, along with the network layer parameters, to the PPP access terminal comprises:
after the PPP access terminal is powered on, initiating a PPP access request;
performing a link layer parameter negotiation between the PPP access terminal and the PPP server, and establishing a communication link;
performing a network layer parameter negotiation between the PPP access terminal and the PPP server, and acquiring an IP address and the address information of the network management/auto-configuration server.

4. The method for implementing automated service provisioning on the PPP access terminal according to claim 3, wherein said process of acquiring the IP address and the address information of the network management/auto-configuration server comprises:
the PPP server sending the address information of the network management/auto-configuration server, carried by an IP control protocol-based IPCP message, to the PPP access terminal.

5. The method for implementing automated service provisioning on the PPP access terminal according to claim 3, wherein the process of initiating the PPP access request after said PPP access terminal is powered on comprises:
the PPP server determining an address of the network management/auto-configuration server according to local configuration information;
or,
the PPP server acquiring the address of the network management/auto-configuration server from an entity allocated with the address information of the network management/auto-configuration server.

6. The method for implementing automated service provisioning on the PPP access terminal according to claim 1, wherein said PPP server comprises:
a broadband access server (BRAS) or an edge router (ER).

7. The method for implementing automated service provisioning on the PPP access terminal according to claim 1, wherein said process of acquiring the configuration information needed for launching the service comprises:
the PPP access terminal requesting a network management system for terminal software and terminal configuration files, according to the verified address information of the network management/auto-configuration server;
the PPP access terminal acquiring and running the corresponding terminal software and terminal configuration files.

8. The method for implementing automated service provisioning on the PPP access terminal according to claim 7, wherein the process of said PPP access terminal launching the service using said configuration information comprises:
the PPP access terminal, having run the corresponding terminal software and configuration files, requesting the service system for the service, and said service system responding to a service request of the PPP access terminal.

9. A system for implementing automated service provisioning on a PPP access terminal, comprising a PPP access terminal, a PPP server, and a network management/auto-configuration server, characterized by including an address information distribution unit and an address information receiving unit, or an address configuration unit; and also including a configuration information acquisition unit and a service processing unit, wherein:
the address information distribution unit, setup at the PPP server, being used for sending address information of the network management/auto-configuration server, along with network layer parameters, to the PPP access terminal, after the PPP access terminal accessing the network;
the address information receiving unit being used for receiving the network layer parameters sent via the address information distribution unit by the PPP server;
the address configuration unit, set up in the PPP access terminal, being used for acquiring configured and imported address information of the network management/auto-configuration server;
the configuration information acquisition unit, set up at the PPP access terminal, being used for automatically acquiring configuration information needed for launching a service from the network management/auto-configuration server, based on the address information received by the address information receiving unit or configured by the address information configuration unit;
the service processing unit, set up at the PPP access terminal, being used for utilizing said configuration information for launching the service.

10. The system for implementing automated service provisioning on a PPP access terminal according to claim 9, wherein said address information distribution unit is triggered by a PPP access request initiated by the PPP access terminal.

11. The system for implementing automated service provisioning on a PPP access terminal according to claim 9, wherein said address information distribution unit sends the address information of the network management/auto-configuration server, carried by IP control protocol-based IPCP message, to the PPP access terminal.

12. The system for implementing automated service provisioning on a PPP access terminal according to claim 9, wherein said PPP server also includes:
an address information management unit used for local management at the PPP server the address information of the network management/auto-configuration server;
or,
an address information acquisition unit used for acquiring an address of said network management/auto-configuration server from an entity allocated with the address information of the network management/auto-configuration server.

13. The system for implementing automated service provisioning on a PPP access terminal according to claim 9, wherein said PPP server includes a broadband access server (BRAS) or an edge router (ER).

14. A PPP access terminal, comprising:
an address information configuration unit used for acquiring configured and input address information of a network management/auto-configuration server;
a configuration information acquisition unit used for automatically acquiring configuration information needed for launching a service from the network management/auto-configuration server, according to the address information configured by the address information configuration unit;
a service processing unit used for launching the service using said configuration information.

15. A PPP access terminal, comprising:
an address information receiving unit used for receiving network layer parameters sent from a PPP server, said network layer parameters including address information of a network management/auto-configuration server;
a configuration information acquisition unit used for automatically acquiring configuration information needed for launching a service from the network management/auto-configuration server, according to the address information received from the address information receiving unit;
a service processing unit used for launching the service by using said configuration information.
